(19) United States
(12) Patent Application Publication
(10) Pub. No.: US 2003/0128859 A1
(43) Pub. Date: Jul. 10, 2003

(54) System and method for audio enhancement of digital devices for hearing impaired

(75) Inventors: David Perry Greene, Ossining, NY (US); Paul Andrew Moskowitz, Yorktown Heights, NY (US); Stephen J. Boies, Mahopac, NY (US); Edith Helen Stern, Yorktown Heights, NY (US); Barry Edward Willner, Briarcliff Manor, NY (US); Philip Shi-lung Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/041,294

(22) Filed: Jan. 8, 2002

(51) Int. Cl. H04R 1/02

(52) U.S. Cl. 381/351

(57) ABSTRACT

The present invention provides a system and method for accessing, transmitting and storing a client's hearing profile on a network, which results in the creation of an audio font that is customized to the client's hearing preferences. In turn, the client's audio font may be accessed by the client and transmitted to a client's selected digital audio device via a network connection, which attenuates the sound drivers of the digital audio device to properly filter and adjust audio output in a manner that best enhances the sound quality to the client's needs and preferences. The invention allows the client to customize the sounds emitted from digital audio devices by providing audio preference feedback which modifies the selected audio font to more accurately represent the audio preferences of the client.

### BACKGROUND OF THE INVENTION

1. Technical Field

The present disclosure relates to digital hearing aids, and more specifically to digital audio devices where the audio output may be customized to a client's individual hearing profile which is stored on a network database.

2. Description of Related Art

Dysaudia or deafness can be generally classified into conduction deafness and perceptive deafness. Conduction deafness is such a condition that sound itself is not sufficiently transmitted because of abnormality in the external ear or middle ear. Conduction deafness may be satisfactorily compensated by a conventional analog hearing aid.

However, perceptive deafness is a condition where it is difficult to even sense sound because of an abnormality in the internal ear. Perceptive deafness is attributable to various causes, for example, lack of a stereocilium at the tip end of frondose cells in the cochlea, or trouble in the audio nerve for transmitting a sound. A senile deafness is included in the perceptive deafness. Perceptive deafness can be hardly overcome by the conventional analog hearing aid, and attention has been focused on a digital hearing aid capable of performing complicated signal processing functions to overcome perceptive deafness.

Typical perceptive hearing impairment occurs at select frequency bands which are different for different individuals. Uniform elevation of output volume only addresses those bands which are partially impaired, which only results in partial hearing aid to the client. In addition, clients with perceptive deafness may exhibit various symptoms, each of which may be vastly different from one client to another. For instance, one common symptom of perceptive deafness includes a loudness recruitment phenomenon, in which a minimum level capable of hearing (minimum threshold of audibility) elevates, but a maximum level (maximum threshold of audibility) does not greatly differ, with the result that the client's audible range is narrowed. This change may then, and usually does, differ from one frequency to another.

In order to compensate for the recruitment in perceptive deafness, the hearing aid is required to convert an input signal, which varies in frequency and strength, into an output signal in matching with a hearing characteristics of a person to be fitted with the hearing aid. Therefore, a time-variant filter may be used in the digital hearing aid to change the characteristics of the hearing aid in response to both the input signal and the hearing characteristics of the person to be fitted with the hearing aid. Examples of prior art disclosing apparatus capable of performing these functions include the digital hearing aid disclosed in U.S. Pat. No. 5,892,836 (Ishige, et al.) and U.S. Pat. No. 6,212,496 (Campbell, et al.) which contains disclosure directed to customizing audio output to a client from a digital telephone.

Although the cited prior art discloses hardware sufficient to deliver customized audio output to the hearing impaired, a need still exists for an improved method of recording a client's unique hearing profile preferences and implementing the audio profile in present digital audio devices from a common database with controlled access. Likewise, a need exists for an improved method of generating and storing various audio profiles whereby a client may select and implement a specific audio profile for use in a digital audio device.

### SUMMARY OF THE INVENTION

The present invention provides a method for accessing and storing on a network a client's audio profile, which results in the creation of a sound template (hereinafter “audio font”) that is customized to the client's hearing preferences. In turn, the client's audio font(s) may be accessed by the client's digital hearing aid or digital audio device (collectively “digital audio device”) via a network connection, which allows the digital audio device to properly filter and adjust audio output in a manner that best enhances the sound quality to the client's needs and preferences. The audio font customizes the emission of sound from digital audio devices at frequencies and volumes which make sounds clear, distinct or desirable to the client.

The objects of the present invention may be achieved by a utilizing a digital audio device having variable sound conditioning and compensating characteristics, comprising an audio compensating means with a transposed transversal filter receiving an input signal for outputting a compensated output signal, an analyzing means receiving the input signal for frequency-analyzing the input signal, a memory means for storing an audio profile consisting of the hearing characteristics of the person to be fitted with the hearing aid or utilizing the digital audio device, and a control means receiving a frequency analysis result of the input signal from the analyzing means and the hearing characteristics from the memory means for deriving coefficients for the transposed transversal filter to supply the derived coefficients to the transposed transversal filter. Such devices are known in the art as disclosed by U.S. Pat. No. 5,796,848 (Martin) and U.S. Pat. No. 6,212,496 (Campbell, et al.).

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a digital hearing device networked with an audio font database via a network connection;

FIG. 3 is a flowchart depicting a preferred embodiment of the present invention wherein the client's audio font is stored on a network and may be accessed by networked digital audio devices at the request of the client; and,

FIG. 4 is a flow diagram of an alternative embodiment of the present invention providing for the transmission of audio font information on a continuous basis.

### DETAILED DESCRIPTION OF THE PREFERRED EMBODIMENT

With reference now to the figures, FIG. 1 depicts a representation of a distributed data processing system 100 in which the present invention may be implemented. Distributed data processing system 100 contains a communications network 102, which is the medium used to provide communication links between the various devices and computers connected together within distributed data processing system 100. Network 102 may include permanent connections such as wire, fiber optic cable, or temporary connections made through telephone connections. Communications network 102 may also include public and/or private wide area networks, local area networks, wireless networks, intranets, routers, satellite links, microwave links, radio links, and cellular or telephone networks. In some embodiments as used herein, communications network 102 may include those networks enabled by wired or wireless technology.

In the depicted example, an audio font service provider 104, database 106, client 108, and digital audio device 110 are shown connected to network 102. Service provider 104 and database 106 may represent a third party vendor which provides hearing evaluation and audio font customization services to hearing impaired clients, such as client 108. Client 108 may access the service provider and databases via personal computers, portable computers, mobile or fixed user stations, workstations, network terminals or servers which may or may not be integrated with a digital audio device 110 which may be personal computers, cellular phones, personal digital assistants, audio/video receivers, kiosks, information appliances, televisions other audio/video appliances. Service provider 104 and database 106 both transmit and receive data, such as data files, operating systems, images, sounds and applications to and from client 108 and digital audio device 110. It should be noted that distributed data processing system 100 may include additional servers, databases, clients, and other devices which are not shown.

The service provider 104 includes at least one registration server. It is sufficient to note that the service provider 104 includes a registration manager and a registration database for new client user registration. In the preferred embodiment, client audio fonts are not stored on the service provider 104 server, but instead stored for recall and access on database 106 by clients 108 and digital audio devices 110.

The service provider 104 may include one or more servers and databases. Each server and database is linked by network 102 for network communications with the service provider 104 registration server. In an embodiment containing a single service provider 104, such as the embodiment illustrated here, each registration server and database has a connection through network 102 (or may readily obtain such a connection) to service provider 104. Each network link may involve a dedicated link, a virtual circuit, a tunnel through one or more intervening networks, or one or more other types of network communications links known to those of skill in the art.

The service provider 104 server contains the registration and billing information of clients 108 and/or other client profile information managed by the architecture. Each service provider 104 server or database 106 provides the client's 108 audio font to digital audio devices 110 at the direction of the clients 108 which have registered with the service provider 104. At a minimum, registration provides clients 108 with a unique user ID or may also coordinate a password or otherwise manage access control to the clients' 108 audio profile and registration information. With the possible exception of registration for free demonstrations, which may be available in some embodiments, registration also obtains billing or payment information such as the client's 108 credit card information, purchase order and/or sponsor identity.

The service provider 104, database 106, client 108 and digital audio devices 110 may be implemented with a combination of computer hardware (e.g. disk or other non-volatile storage media, RAM or other volatile storage, one or more processors, network interface cards, supporting I/O equipment) and computer software (operating system software, networking software, web browser software, and inventive software as described herein). In particular, suitable software for implementing the invention is readily provided by those of skill in the art using the teachings presented here and programming languages and tools such as Java, Pascal, C++, C, CGI, Perl, SQL, APIs, SDKs, assembly, firmware, microcode, and/or other languages or tools.

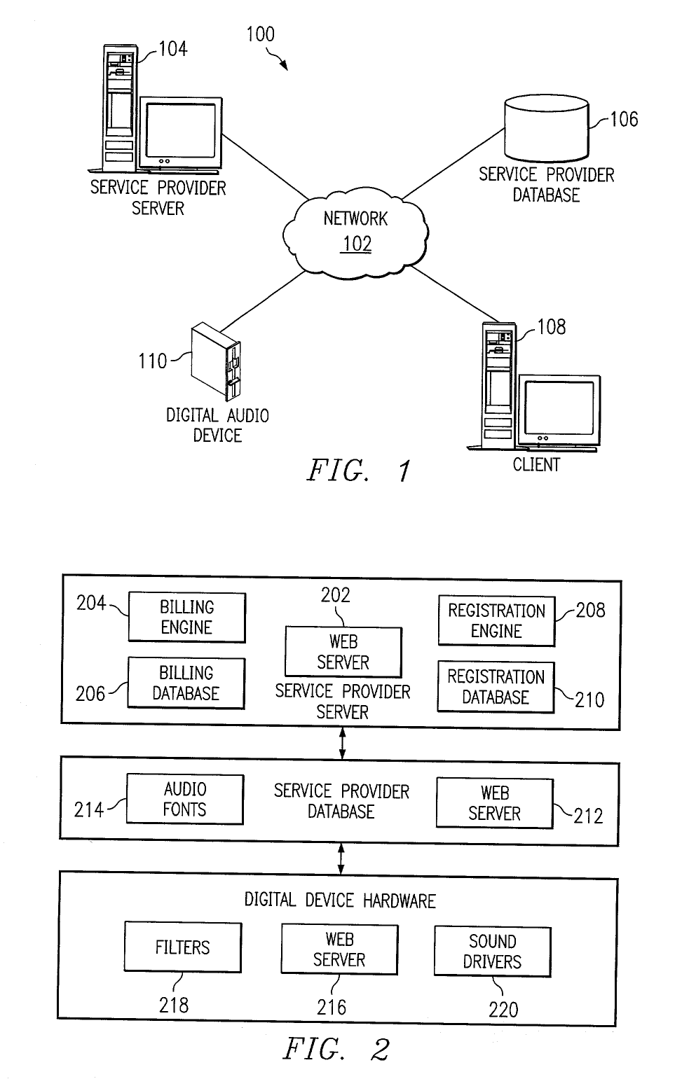

FIG. 2 represents a block diagram of the preferred embodiment wherein the service provider 104 server, service provider database 106 and digital audio device 110 architecture is presented in greater detail. The service provider 104 server is shown integrated with a server level system composed of a web server 202, billing engine 204, billing database 206, registration engine 208 and registration database 210. The service provider database 106 is shown integrated with web server 212 and audio font database 214. Digital audio device 110 is shown integrated with a web server 216, sound filters 218 and sound drivers 220 (collectively “output drivers”) which provide for communication with service provider 104 servers and service provider databases 106 and the conditioning of sound as directed by the audio font accessed via webserver 216 and implemented by the sound filters 218 and sound drivers 220 when sound conditioning is requested by the client 108. In embodiments where the audio font information is provided by a service provider 104, a client 108 may be charged a predetermined fee for the audio font service in a variety of ways, including but not limited to, a fee per each download of the audio font to a digital audio device 110, a fee per unit of time of transmission to a digital audio device 110, or at the time the client 108 creates a profile with the service provider 104.

The service provider database 106 also is equipped with software which provides for the correlation of the client's 108 baseline hearing patterns to the client's 108 audio font, which in turn provides operational instructions to the digital audio device 110 processors, sound filters 218 and sound drivers 220 utilizing digital signal processing technology, such has the digital hearing aid apparatus disclosed in U.S. Pat. No. 6,240,192 (Brennan, et al.). For the purposes of the present invention, digital audio devices 110 containing hardware identical or similar to the device disclosed in U.S. Pat. No. 6,240,192 would be able to receive appropriate audio font operational instructions from the service provider 104 and also have the capability to receive additional modified audio fonts as the client's hearing profile changes over time.

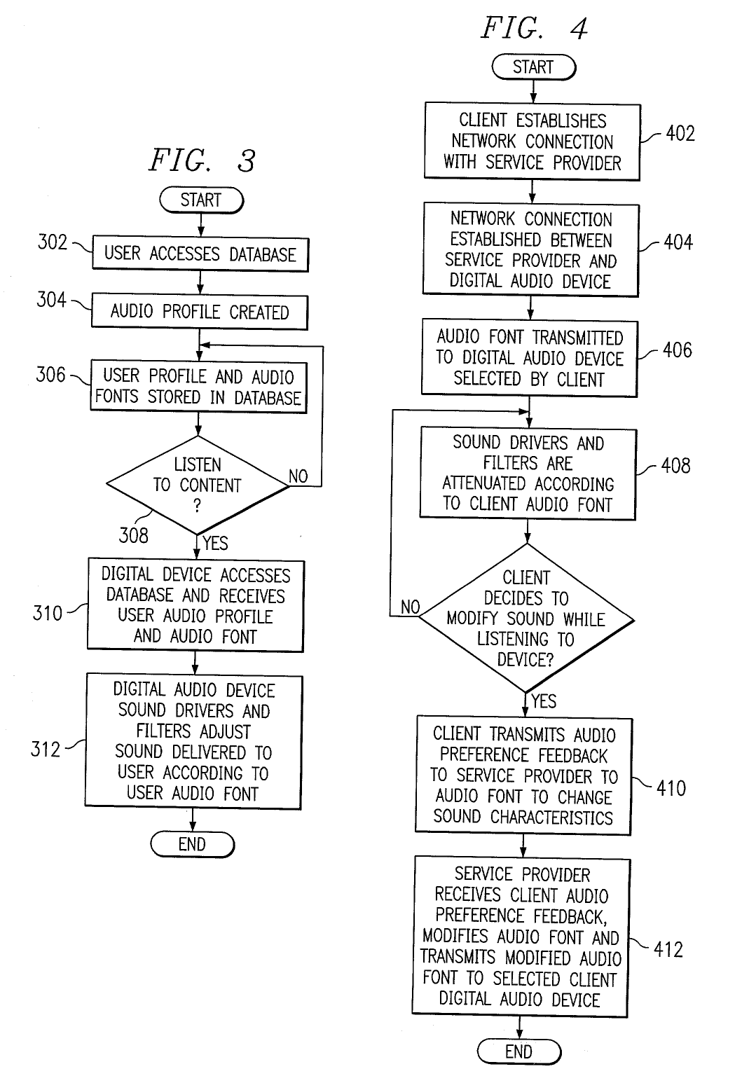

Turning to FIG. 3, a preferred embodiment of the present invention is depicted which presents a method by which client audio fonts are accessed and utilized by digital audio devices 110. In this embodiment, the client registers with the service provider and inputs his baseline hearing characteristics and billing information (Step 302). The service provider matches the client's audio profile with the appropriate audio font based on the client's hearing characteristics (Step 304). The client is assigned a unique client identification number which is indexed with the client's audio profile and font(s) which are stored on the service provider's server or database (Step 306). The client's audio font(s) may also be indexed with context information (such as the device or situation of use) to enable greater customization to the individual's preferences. When the client desires to listen to audio content from a digital audio device, the client accesses the service provider server and transmits his unique identification number which is received and authenticated by the service provider (Step 308). Next, the service provider transmits the client's audio font to the selected digital audio device (Step 310). The digital audio device receives the client audio font whereby the integrated digital signal processor, sound drivers and filters make the appropriate modifications to the frequency and volume of the sound emitted from the device (Step 312). After the download of the audio font is completed, the client is charged a fee by the service provider. It should be noted that if the client desires to modify the sound emitted from the client's digital audio device, the client may access the audio profile on the service provider's database and modify the selected audio font according to his or her preferences and the appropriate audio font modifications which may then be downloaded to the client's selected digital audio device as shown in FIG. 4.

Turning to FIG. 4, an alternative embodiment for transmitting the client's audio font to a digital device is shown. FIG. 4 depicts a method for transmitting audio font information to a digital device on a continuous basis. For example, the client establishes a network connection with the service provider (Step 402). In this scenario, the client has previously registered with a service provider and established an audio profile containing at least one audio font. Next, a network connection is established between the service provider and the client's selected digital audio device (Step 404). The client's selected audio font is transmitted to the client's selected digital device which receives the audio font information (Step 406). The sound drivers and filters of the selected digital audio device are then attenuated according to the received audio font (Step 408). If, while listening to audio content, the client decides to utilize a different audio font or desires to make adjustments to the current audio font, the client may make the desired audio font selection or modification by sending audio preference feedback to the service provider over the existing network connection (Step 410). The service provider receives the client's audio preference feedback, makes the appropriate modifications to the client's audio font(s) and transmits the modified audio font(s) to the selected digital audio device which implements the appropriate adjustments to the sound driver's and filters on the selected digital audio device (Step 412). The continuous transmission of audio font information and client audio preference feedback over an existing network connection allows the client to manipulate the sound emitted from a digital audio device while concurrently listening to sound emitted from the device. Likewise, the service provider may accordingly charge the client a fee based on a pay per unit of time while the continous connection is established between the service provider and the selected digital audio device or other alternative billing plan utilized by the service provider.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The preferred embodiment was chosen and described in order to best explain the principles of the invention, the practical application, and to enable others of ordinary skill in the art to understand the invention for various embodiments with various modifications as are suited to the particular use contemplated.

What is claimed is:

1. A method of customizing audio output from a digital audio device comprising:
creating at least one client audio profile according to the client's hearing characteristics;
associating the client profile with at least one audio font; and,
accessing the client profile and retrieving the associated client audio font.

2. The method of claim 1 further comprising:
transmitting the client audio font via a network to a selected client digital audio device; and,
conditioning an audio signal emitted from the client digital audio device according to the received client audio font.

3. The method of claim 1 wherein an audio test is conducted via a network to establish the client's audio profile.

4. The method of claim 2 wherein the network is the Internet, a wireless communication network, a local area network, a wide area network, a satellite communication network, or a telephone network.

5. The method of claim 1 wherein the digital audio output device is at least one of a television, a camera, a camcorder, a home theater, a stereo amplifier, a digital tuner, a digital video disk player, a compact disc player, a computer, a video cassette recorder, a digital radio, or a telephone.

6. The method of claim 2 further comprising:
providing client feedback while using an audio font; and,
modifying the audio font according to the client audio preference feedback.

7. The method of claim 6 wherein the client audio preference feedback and modification of the audio font is transmitted via a network.

8. The method of claim 7 wherein the network is the Internet, a wireless communication network, a local area network, a wide area network, a satellite communication network, or a telephone network.

9. The method of claim 7 wherein the client audio font is constantly transmitted to a digital audio device.

10. The method of claim 7 wherein the client audio font is transmitted to a digital audio device on a download per device basis.

11. The method of claim 7 wherein the client audio font is transmitted to a digital audio device on a per unit of time basis.

12. An apparatus for customizing audio output from a digital audio device comprising:
means for creating at least one client audio profile according to the client's hearing characteristics;
means for associating the client profile with at least one audio font; and,
means for accessing the client profile and retrieving the associated client audio font.

13. The apparatus of claim 12 further comprising:
means for transmitting the client audio font via a network to a selected client digital audio device; and,
means for conditioning an audio signal emitted from the client digital audio device according to the received client audio font.

14. The apparatus of claim 12 further comprising means to conduct an audio test via a network to establish the client's audio profile.

15. The apparatus of claim 13 wherein the network is the Internet, a wireless communication network, a local area network, a wide area network, a satellite communication network, or a telephone network.

16. The apparatus of claim 13 wherein the digital audio output device is at least one of a television, a camera, a camcorder, a home theater, a stereo amplifier, a digital tuner, a digital video disk player, a compact disc player, a computer, a video cassette recorder, a digital radio, or a telephone.

17. The apparatus of claim 13 further comprising:
means for providing client feedback while using an audio font; and,
means for modifying the audio font according to the client's audio preference feedback.

18. The method of claim 17 wherein the client's audio preference feedback and modification of the audio font is transmitted via a network.

19. The method of claim 17 wherein the network is the Internet, a wireless communication network, a local area network, a wide area network, a satellite communication network, or a telephone network.

20. The method of claim 17 wherein the client audio font is constantly transmitted to a digital audio device.

21. The method of claim 17 wherein the client audio font is transmitted to a digital audio device on a download per device basis.

22. The method of claim 17 wherein the client audio font is transmitted to a digital audio device on a per unit of time basis.

23. A computer program product for customizing audio output from a digital device comprising:
first instructions for creating at least one client audio profile;
second instructions for associating the client profile with at least one audio font; and,
third instructions for accessing the client profile and retrieving the associated client audio font.

24. The computer program product of claim 23 further comprising:
fourth instructions for transmitting the client audio font via a network to a selected client digital audio device; and,
fifth instructions for conditioning an audio signal emitted from the client digital audio device according to the received client audio font.

25. The computer program product of claim 24 further comprising instructions sixth instructions to conduct an audio test to establish the client's audio profile.

26. The computer program product of claim 24 further comprising:
sixth instructions for providing client feedback while using an audio font; and, seventh instructions for modifying the audio font according to the client's audio preference feedback.
